(19) United States
(12) Patent Application Publication
(10) Pub. No.: US 2012/0163434 A1
(43) Pub. Date: Jun. 28, 2012

(54) DIGITAL RECEIVER FOR MOBILE COMMUNICATION AND OPERATING METHOD

(75) Inventors: Sang-Kyun Kim, Mungyeong (KR); Mijeong Park, Gongju (KR); Ik Soo Eo, Daejeon (KR); Hyun Kyu Yu, Daejeon (KR)

(73) Assignee: Electronics and Telecommunications Research Institute, Daejeon (KR)

(21) Appl. No.: 13/331,252

(22) Filed: Dec. 20, 2011

(30) Foreign Application Priority Data
Dec. 23, 2010 (KR) 10-2010-0134103

(51) Int. Cl. H04B 1/38; H04L 27/00

(52) U.S. Cl. 375/222; 375/316

(57) ABSTRACT

This invention is regarding mobile communication digital receiver and operating methods of a digital front end, which uses a digital mixer to change the center frequency to DC; a digital mixer allows the user to evade I/Q mismatch challenges; an Analog-to-Digital Converter (ADC) converts a Radio Frequency analog signal to a digital signal; a digital mixer converts the ADC's output signal's center frequency to DC; a digital front end has an automatic gain control over multiple frequency bands and contains a noise filter; a modem receives the digital front end's output and demodulates the signal.

### CROSS-REFERENCES TO RELATED APPLICATIONS

The present application claims priority under 35 U.S.C 119(a) to Korean Application No. 10-2010-0134103, filed on Dec. 23, 2010 in the Korean intellectual property Office, which is incorporated herein by reference in its entirety set forth in full.

### BACKGROUND

Exemplary embodiments of the present invention relate to a digital receiver for mobile communication purposes, and more particularly, a DFE's structure and operational method.

Conventionally, a Digital Front-End (DFE) processes an incoming signal received from the Analog-to-Digital Converter (ADC) until the signal is baseband.

One of the important trends in the design of Radio Frequency (RF) receivers and wireless devices is to move the functions of the analog Integrator & Differentiator blocks to those of the Digital Signal Processor (DSP) blocks.

The implementation of a digital design is not only able to reduce time consumption, power consumption and area size, but also is able to support multiple modes and multiple bands. This is where the digital front end serves its purpose.

A digital front end can be configured to suit various needs. The main elements comprising the digital front end are a decimator, a noise digital filter, and a sampling rate converter. The decimator receives a high ADC sampling frequency output signal and basebands the signal while maintaining information received within the data. A digital filter is then used to remove noise. Finally, if the sampling rate of the received signal is different from the required sampling rate of the modem, a sampling rate converter is used to change to the correct sampling rate.

Existing digital front ends of digital receivers using a mixer before the ADC to convert the signal to DC may have zero-IF, zero-Intermediate frequencies. In these cases, an analog local oscillator is used and a mismatch occurs when In-phase (I) and Quadrature-phase (Q) data is separated. In addition, a Variable Gain Amplifier (VGA) before the ADC is used to meet the Signal-to-Noise Ratio (SNR). However, if the incoming signal to the ADC is a multi-mode, multi-band signal, the ADC's signal output SNR may not be consistent. In these circumstances, a VGA before the ADC may not be an effective method to control the signal. Furthermore, a typical solution is to create signal paths configured specifically for each band or mode. However, this solution will increase the size of hardware used.

### SUMMARY

An embodiment of the present invention relates to a mobile communication receiver's DFE using a digital mixer to change to DC, thereby likely solving the I/Q mismatch problem. In addition, to satisfy multi-mode and multi-band signals, methods and their structures for using the filter including a Digital Automatic Gain Control (DAGC) device are provided.

The scope of the invention is not limited by the above-mentioned challenges.

A DFE device and its operational method is provided which describes a mobile communication system using minimum hardware resources while supporting a wide frequency bandwidth. Although the Long Term Evolution (LTE) standard stipulates six frequency bandwidths (20 MHz, 15 MHz, 10 MHz, 5 MHz, 3 MHz, 1.4 MHz), the described invention herein can also handle other frequency bands in addition to LTE's standard.

An embodiment of the present invention relates to a digital receiver for mobile communications, comprising: an Analog-to-Digital Converter (ADC) configured to convert a radio frequency analog signal to a digital signal; a Digital Front End including a digital mixer to convert the ADC output signal to have a center frequency at DC, and a filter to satisfy a multi-band signal through automatic gain control; and a modem configured to receive the Digital Front End's output signal and perform demodulation.

The clock rate of a clock inputted to digital mixer may be configured to have the same speed as the sampling rate of the output signal of the ADC.

The digital mixer may include a numerical controlled oscillator and a multiplier for separating the output signal of the ADC into an in-phase signal and a quadrature-phase signal.

The Digital Front End may include: a Digital Front End filer configured to remove the noise of the output signal of the ADC in order to obtain the Signal-to-Noise Ratio required by the modem.

The Digital Front End may include: a Cascaded Integrator Comb filter configured to receive the output of the digital mixer; a first Finite Impulse Response filter configured to receive the output of the Cascaded Integrator Comb filter; a Sample rate converter configured to receive the output of the first Finite Impulse Response filter; a second Finite Impulse Response filter configured to receive the output of the Sample rate converter; and a digital automatic gain control block configured to receive the output of the second Finite Impulse Response filter.

The digital automatic gain control block may identify a valid bit of the output of the digital front end filter in order to handle fluctuation of the signal magnitude due to a interference signal or characteristics of the multi-band signal.

The digital front end filter may convert the sampling rate of the ADC output to match the sampling rate required by the modem.

The Digital Front End filter may decimate the input signal.

The Cascaded Integrator Comb filter may include a MUX and a plurality of Sub-Cascaded Integrator Comb filters.

The digital automatic gain control block may have a feed-forward structure and may include: a control signal generator; a power detector; a power estimation block; a normalization block; and a digital Variable Gain Amplifier (DVGA).

The Cascaded Integrator Comb (CIC) filter may include: “M” sub-CICM filters, where the ‘k’-th sub-CICM filter receives the output of the ‘(k−1)’-th sub-CICM filter; and a multiplexer that receives the outputs of the “M” sub-CICM filters, wherein “M” is an integer with a value greater than or equal to 1, and ‘K’ is an integer greater than 1 but less than or equal to “M”.

At least one sub-CICM filter of the M sub-CICM filters may include: a sub-filter that performs the function of

$${( \frac{1 - {z}^{- K}}{1 - {z}^{- 1}} )}^{N} ,$$

a digital automatic gain control block, and a downsampler, wherein an input signal to the at least one sub-CICM filter passes through the sub-filter, the digital automatic gain control block, and finally to the down sampler, in that sequential order.

The sub-filter may include N functional blocks, wherein each of the N functional blocks contains adders and delay blocks used to perform integral and derivative functions.

The sub-filter may include N functional blocks, and wherein each of the N functional blocks comprises L delay blocks each of which are connected in cascade form, and an adder which adds the output of L delay blocks.

Another embodiment of the present invention relates to an operating method of a digital receiver, includes: converting a radio frequency analog signal to a digital signal; converting the center frequency of the digital signal to DC and separating the converted digital signal into an in-phase signal and a quadrature-phase signal; and filtering the in-phase signal and the quadrature-phase signal with a digital front-end filter which conducts digital automatic gain control, and demodulating the filtered signals.

The scope of the invention is not limited by the above mentioned effects.

### BRIEF DESCRIPTION OF THE DRAWINGS

The above and other aspects, features and other advantages will be more clearly understood from the following detailed description taken in conjunction with the accompanying drawings, in which:

FIG. 1 is a block diagram outlining the structure for the a mobile communication system receiver of the present invention;

FIG. 2 is a block diagram shown as an example of the structure for the Digital Front End 140 in accordance with the embodiment of the present invention;

FIG. 3 is an example of a structure for a CIC filter 230;

FIG. 4 is an example of a structure for a sub-CIC1 filter 320;

FIG. 5 is another example of a structure for a sub-CIC2 filter 320;

FIG. 6 is an example of a structure for a DAGC1 480 as shown in FIG. 4 and FIG. 5;

FIG. 7 is an example of a structure for a sub-CIC2 filter 330 as shown in FIG. 3; and

FIG. 8 is an example of a structure for a sub-CIC3 340 and a structure for a sub-CICM filter 350, both of which have the same structural content.

FIG. 9 shows an example of the structure of a DAGC2 270 as sown in FIG. 2.

### DESCRIPTION OF SPECIFIC EMBODIMENTS

Hereinafter, a digital receiver for mobile communication and its operational method in accordance with embodiments of the present invention will be described with reference to accompanying drawings. The drawings are not necessarily to scale and in some instances, proportions may have been exaggerated in order to clearly illustrate features of the embodiments. Furthermore, terms to be described below have been defined by considering functions in embodiments of the present invention, and may be defined differently depending on a user or operator's intention or practice. Therefore, the definitions of such terms are based on the descriptions of the entire present specification.

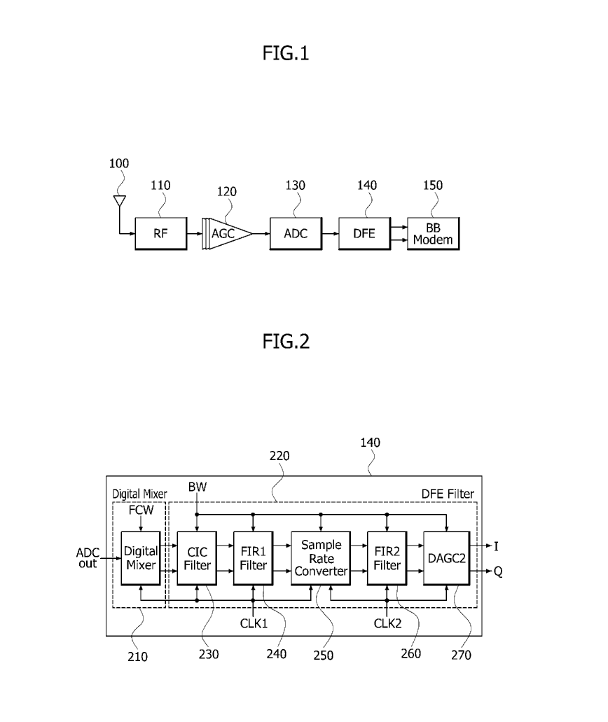

FIG. 1 is a block diagram outlining the structure for the a mobile communication system receiver of the present invention.

FIG. 1 illustrates a mobile communication system which includes an antenna 100 for receiving transmitted broadcast signals, an RF processing block 110 that converts the received signal from the antenna 100 to the desired Intermediate Frequency (IF) pass-band signal, an Automatic Gain Control block (AGC) 120 that controls the magnitude of the pass-band converted signal, an Analog-To-Digital-Converter (ADC) 130 that samples the output signal from the AGC and converts that signal to a digital signal, a DFE 140 processing unit that converts the speed of the sampling rate of the ADC to be the same as the speed of the sampling rate of the BB modem 150 in order to meet the SNR requirements of the BB Modem, and a BB modem 150 to demodulate the received signal. In order for the AGC 120 to maintain a constant input signal magnitude to the ADC, a feature of the invention is the RF processing block 110 outputting a calculated gain value depending on the size of the reference signal which then is multiplied to the output signal.

FIG. 2 is a block diagram shown as an example of the structure for the Digital Front End 140 in accordance with the embodiment of the present invention.

FIG. 2 illustrates the structure of the Digital Front End 140 in more detail.

The DFE 140 may include a digital mixer 210 and DFE filter 220. The digital mixer 210 receives the output signal from the ADC and converts that signal's center frequency to DC, where the Frequency Control Word FCW is referred to for the changing frequency. CLK1 can be used to drive at least 1 DFE filter 220 and the digital mixer. CLK1 enables the ADC 130 to have the same sampling rate as the clock rate. The DFE filter attenuates the noise in the output signal of the ADC 130 to satisfy SNR requirements of the BB modem, converts the sampling rate of the output signal of the ADC 130 to the same speed of the modem's data rate, and can pass the I/Q signals to the BB modem 150. The DFE filter 220 can use both the above mentioned CLK1 and the CLK2 with the BB modem 150's clock rate. Also, the receiver is able to use a control signal bandwidth in order to have the flexibility to work for a number of different bands.

The DFE 140 of FIG. 2 includes Digital Automatic Gain Control 2 (DAGC2) 270 that can find a significant bit of the filter output in order to deal with the fluctuation of the signal magnitude occurred by a multi-band signal or an interference signal.

The DFE filter 220 in FIG. 2 may include a CIC filter 230, a first Finite Impulse Response filter (FIR1) 240, a sample rate converter 250, a second Finite Impulse Response filter (FIR2) 260, and a DAGC2 270. The control signal is a BW signal inputted to each of the components in the DFE filter 220, which is used to be able to dynamically control multi-bands in the DFE filter 220. For example, if the input signal's frequency bandwidth is 20 MHz, 15 MHz, 10 MHz, 5 MHz, 3 MHz, 1.4 MHz, the BW signal may take on values 1, 2, 3, 4, 5, and 6. If the BW value is between 1 and “M”, “M” will represent the number of frequency bands supported by the system.

The CIC filter 230 receives and processes the I/Q signal outputted from the digital mixer 210I AND Q, which can have a relatively high signal sampling frequency. Therefore, the CIC filter 230 may perform decimation on high-frequency signals. A control BW input signal may be inputted to allow dynamic use of multiple bands in the DFE filter 220, and the CIC filter 230 may apply varying decimation rates for each of the different frequency BWs. In addition, a digital automatic gain control (DAGC1) identifies a valid bit of the output of the digital front end filter in order to handle fluctuation of the signal magnitude due to a interference signal or characteristics of the multi-band signal. This operation may use the CLK1 signal.

The FIR1 filter 240 is provided to compensate for the distortion that may be caused when the CIC filter 230 is used and the CIC compensation filter as a FIR structure is used. The FIR1 filter also receives the bandwidth signal input, receives a factor value equal to the number of taps for each band, and then uses them flexibly. Using the same multiple of decimation, each band have common coefficient values which is used to reduce the size of the hardware. FIR1 filters 240 may use the CLK1 signal.

A Farrow filter may be used in the sampling rate converter 250 to convert the output of the FIR1 filter's 240 sampling rate to the sampling rate required by the modem. A BW signal input is received and multiple bands can be used flexibly. Again, in order to reduce hardware size, a MUX is selected and used to determine whether to use the same rate converter 250 when the re-sample rate is the same, otherwise when the re-sampling rate is different, to calculate the delay values of a Farrow filter. The sample rate converters 250 may use CLK1 and CLK2 to change the sample rate of the signal.

FIR2 filter 260 uses a Channel Selection Filter (CSF) FIR structure in order to eliminate noise from the originally transmitted signal. The FIR1 filter also receives the bandwidth signal input, receives a factor value equal to the number of taps for each band, and then uses them flexibly. To reduce hardware size, the same filter can be used when the sampling frequency and the signal bandwidth ratio is the same. FIR2 Filters 441 may use the CKL2 signal to operate. The DAGC2 block 270 automatically adjusts the magnitude of the block to match what is required of the modem.

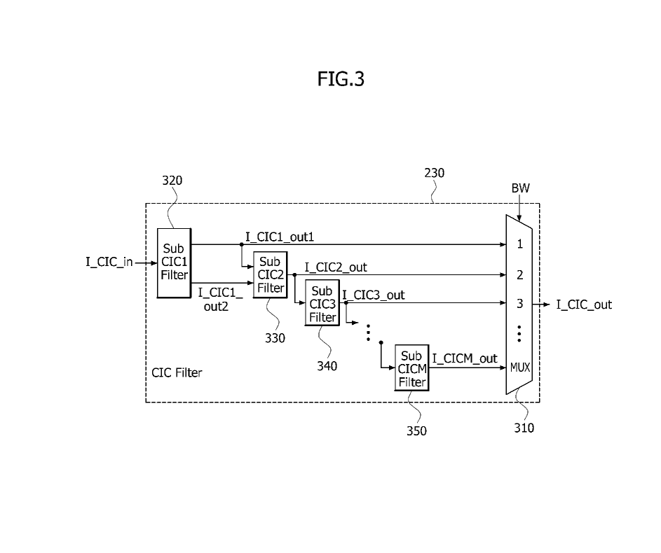

FIG. 3 shows an example of a structure for a CIC filter 230.

The CIC filter 230 may include a MUX 310, a sub-CIC1 filter 320, sub-CIC2 330, sub-CIC3 filter 340, and a sub-CICM filter 350.

In order to minimize hardware resource usage and support a wide frequency BW in the CIC filter 230 of FIG. 3, the number of duplicate hardware can be reduced depending on the BW value. Therefore, the sub-CIC filters 320, 330, 340, 350 are cascaded in placement, depending on the BW value select a cascade output value, and output the signal. In addition, a new form of the CIC filter is configured by combining the DAGC1 in order to respond to the fluctuations in the CIC input signal.

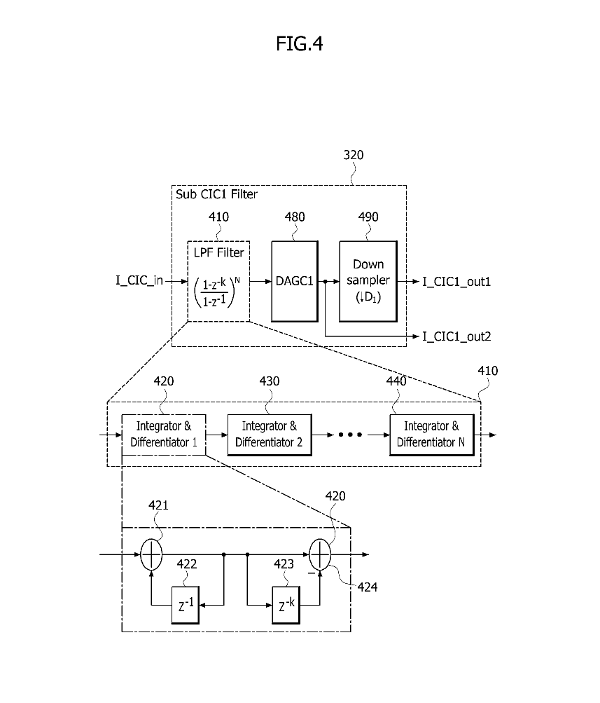

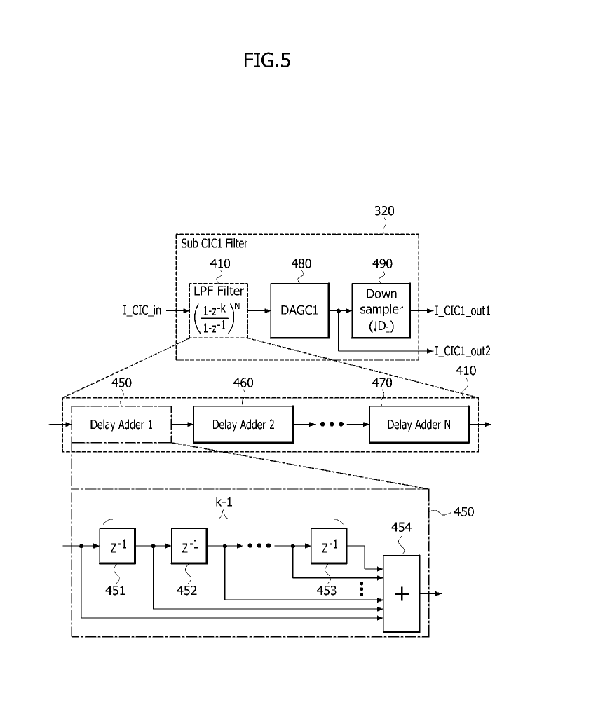

FIG. 4 shows an example of a structure for the sub-CIC1 filter 320 as illustrated in FIG. 3.

The Sub CIC1 filter 320 may include an Low Pass Filter (LPF) 410, a DAGC1 480, and a down sampler 490. The LPF 410 performs the same function as equation 1, and may include an integrator and differentiator1 420, integrator and differentiator 2 430, and an integrator and differentiator N 440 without a multiplier. The integrator and differentiator blocks 420, 430, 440 may be cascaded N times. As N increases, there is an advantage of increased attenuation of the CIC. For each integrator and differentiator block 1˜N 420, 430, 440, the integrator is comprised of an adder 421 and a delay block 422, and a differentiator block is comprised of an adder 424 and “K” delay blocks 423. Although as N increases there is good spectral attenuation, if there is disparity in the control of signal magnitudes within the multi-band BW such as in multiband signals, or if there is a large change in SNR, the output's range of valid bits may widen after passing through the LPF 410. However, as the number of bits increase and hardware complexity increases, an appropriate number the bits are selected to match the number of fixed output bits of the input signal with varying magnitude of the DAGC1 block 480, and acts to control the gain. The down sampler 490 receives an integer value called D1 and outputs only the input sample for each D1 value at a sample rate reduced by 1/D1.

$${( \frac{1 - {z}^{- K}}{1 - {z}^{- 1}} )}^{N} \qquad [ Equation ( 1 ) ]$$

FIG. 5 shows another example of the structure for a sub-CIC1 filter 320 in FIG. 3.

The sub-CIC1 filter 320 shown in FIG. 5 may include an LPF 410, DAGC1 480, and a down sampler 490. However, the LPF configuration structure and the structure in FIG. 4 may be different.

Because the LPF 410 in FIG. 5 performs the same function as Equation 1, the LPF 410 may include a delay adder1 450, delay adder2 460, and delay adder N 470. N Delay adder blocks 450, 460, 470 can be configured in cascade form. As N value increases, there is an advantage of having increased CIC attenuation. Each adder delay block 1˜N 450, 460, 470 may include K delay blocks 451, 452, 453 and an adder 454. This structure is simple but can use a fast CLK1 in the present invention.

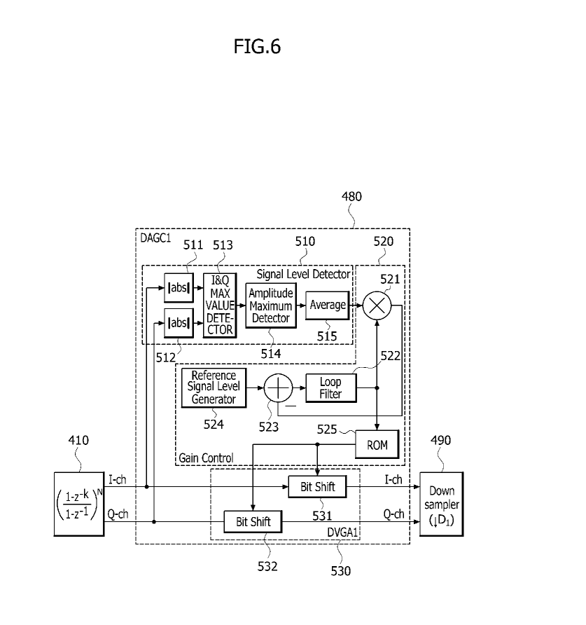

FIG. 6. Shows an example of a structure of the DAGC1 480 shown in FIG. 4 and FIG. 5.

The DAGC1 480 may include a signal level detector 510, a gain control block 520, and a DVGA1 530. The signal level detector 510 obtains the current input signal's magnitude and passes the current input signal's magnitude to the gain control block 520. The gain control block compares the size of the reference signal level and the current input signal's magnitude, determines if the magnitude should be increased or decreased, and via a feedback method uses the DVGA1 530 to apply the change to the input signal magnitude. The DAGC1 530 is simple and therefore can be applied not only to the location where clock rate is high but also anywhere after the digital filter where the effective bit range is wide.

The signal level detector 510 may include an absolute value calculator 511, 512, an I&Q maximum value detector 513, an amplitude maximum detector 514, and an averager 515. Typically, the AGC determines the gain of the signal by comparing the reference signal and the input signal magnitude. However, since operating at a high clock CLK1 finding the LPF 410 output's number of valid bits is a required but simple role, the input of the gain control block 520 will be used with the signal magnitude's maximum value.

The gain control block 520 may include reference signal level generator 524, an adder 523, a loop filter 522, a digital mixer 521, and a ROM 525. The difference between the maximum value of the input signal level from the signal level detector 510 and the desired corresponding output signal value is calculated and obtained using an adder 523. The output of the adder 523 is passed as the input of the loop filter 522, the output of the loop filter 522 is obtained and multiplied by the digital mixer 521 with the maximum value of the input signal from the signal level detector 510, and the output of the digital mixer 521 is placed in a feedback loop in order to obtain the final desired output magnitude level. The output of the loop filter's 522 is sent as an input magnitude value to the DVGA1 530 block. A multiplication to the direct input value to the DVGA1 530 is possible. However even though the DGVA1 530 can multiple and calculate the value, in order to reduce hardware complexity, the output of the loop filter 522 I sent to a ROM 525 which performs (2̂X) to the signal, which can be used in a singular bit shifter 531, 532 in the DVGA1.

The DVGA1 530 may include a bit shifter 531, 532. The output (2̂X) signal value obtained from the gain control block 520 is applied to the signal gain by moving the bits.

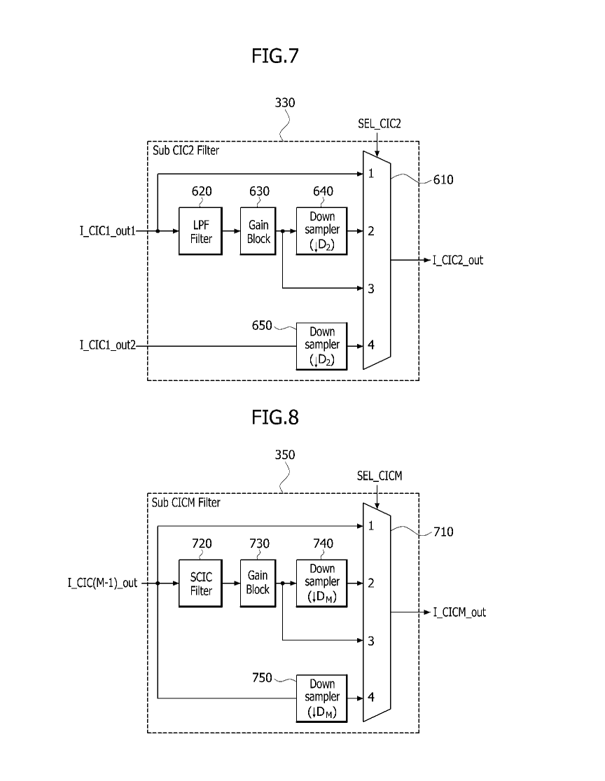

FIG. 7 is an example of a structure for the sub-CIC2 330 of FIG. 3.

The Sub-CIC2 330 may include a MUX 610, LPF 620, gain block 630, and a down sampler 640, 650. A Sub-CIC2 330 control signal is used to allow flexibility in multi-mode, multi-band operation. If the SEL_CIC2 value is 1, the input signal is directly passed onto the output signal. If the SEL_CIC2 value is 2, a decimation value is selected using the LPF 620, the gain block 630, and the down sampler 640. If the SEL_CIC2 value is 3, the applied signal value passing through the LPF 620 and the gain block 630 is selected. If the SEL_CIC2 value is 4, as a different sampling rate is applied from the sub-CIC1 filter 320 of the DAGC1 480, down sampler 650 output is selected. The down sampler 640, 650 receives an input integer value called D₂. For each D₂ value received, the down sampler 640, 650 outputs only the input sample, at a sample rate reduced by 1/D1.

FIG. 8 shows an example of a structure for sub-CIC3 filter 340 or a sub-CICM filter 350.

A Sub-CICM filter 350 may include a MUX 710, SCIC filter 720, gain block 730, and a down sampler 740, 750. A SEL_CICM control signal is used to allow flexibility in multi-mode, multi-band operation. If the SEL_CICM value is 1, the input signal is directly passed onto the output signal. If the SEL_CICM value is 2, a decimation value is selected using the SCIC filter 720, the gain block 730, and the down sampler 740. If the SEL_CIC2 value is 3, the input signal value passing through the SCIC filter 720 and the gain block 730 is selected. If the SEL_CIC2 value is 4, as a different sampling rate is applied from the sub-CICM filter, down sampler 650 output is selected. The down sampler 740, 750 receives an input integer value called D_{M}. For each D_{M} value received, the down sampler 740, 750 outputs only the input sample, at a sample rate reduced by 1/D1.

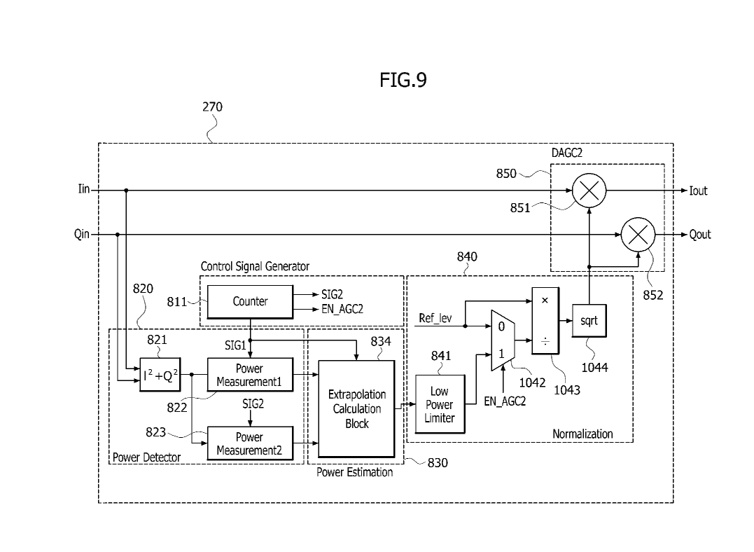

FIG. 9 shows an example of the structure of a DAGC2 270 as sown in FIG. 2.

The DAGC2 270 may include a control signal generator 810, a power detector 820, a power estimation block 830, a normalization block 840, and a DVGA2 850.

The DAGC2 270 uses a feed-forward structure which allows a fast settling time. In addition, in the case of Orthogonal Frequency Division Multiplexing (OFDM) which fluctuate over time, a power level prediction method of a first step extrapolation. If the power level fluctuations are linear in the OFDM, then correction of large variations are also possible.

The power detector 820 may include a power calculation block 821 and a power measure block 822, 823. The power calculation block 821 takes the sum of the squares of I and Q values to calculate power and sends the resulting value to the power measure block 1&2 822, 823 as an input signal. The power measure block 1 822 is used to measure the power values when SIG1 signal is applied. The power measure block 2 823 is used to measure the power values when SIG2 signal is applied.

The extrapolation calculation 834 block in the power estimation block 830 is configured to perform calculations for the signal extrapolation algorithm for signal prediction.

The normalization block 840 may include a low power limiter block 841, a MUX 842, a divider block 843, and a Square Root (sqrt) calculator 844. The low power limiter block 841 is used to restrict values that are too small because if the input values are too small, hardware limitations prevent the division feature of the invention. When the EN_AGC2 value, which specifies the point at which the output of the DAGC2 270 is applied, is 1, The MUX 842 outputs the predicted power output. The predicted power value and the required power signal level value Ref_lev for the BB modem 150 are passed through the divider block 843 and used to normalize the signal. The power value is changed to the voltage value of the signal by the sqrt calculator 844 and inputted into the DVGA2 block 850.

The DVGA2 850 may include a digital mixer 851, 852 which multiplies the normalized gain signal from the output of the multi-band FIR2 filter 260 to meet the input requirements of the modem.

According to an embodiment of the present invention, the following example will use reference numbers in FIG. 1 and FIG. 11.

### Example 1

The present invention can be an embodiment of a digital receiver.

The digital receiver may include ADC 130 that receives an RF signal from the antenna 100 and converts from an analog signal to a digital signal, a DFE 140 that changes the output signal of the ADC to have a center frequency of DC via a digital mixer 210, and a BB Modem that receives the output of the digital mixer and demodulates the data. The digital receiver may also include an RF processing block 110 that processes the data between the antenna 100 and the ADC 130, and an AGC 120 that automatically adjusts the gain of the RF analog signal.

The digital mixer 210 included within the DFE 140 may have an input clock rate that has the same speed as the output sampling rate of the ADC 130.

The digital mixer 210 may include a numerical controlled oscillator and multipliers 310,320 used for separating the output signal of the ADC (130) into an in-phase signal and a quadrature-phase signal.

The DFE 140 may include a DFE filter 220 to remove noise from ADC 130 output signals in order to provide an SNR required by the BB modem 150.

The DFE filter 220 coverts the sampling rate of the ADC 130 to match the sampling rate of the BB modem 150.

The DFE filter 220 decimates the input signal of the DFE filter 220.

The DFE filter 220 may include a CIC filter 230, FIR1 filter 240, Sampling Rate Converter 250, FIR2 filter 260, and a digital DAGC2 270. The output from the digital mixer 210 passes through the CIC filter 230, FIR1 filter 240, sample rate converter 250, FIR2 filter 260, and the DAGC2 270 sequentially in that order.

The DAGC2 270 may include a control signal generator 810, a power detector 820, an extrapolation calculator 830, a normalization block 840, and a DVGA2 850, and may include a with feed-forward structure.

The CIC filter 230 includes M sub-CICM filters 320, 330, 340, 350 and a MUX 310. The MUX 310 receives the outputs of the M sub-CICM filters 320, 330, 340, 350. Among the M sub-CICM filters, the k-th sub-CICM filter receives the (k−1)-th sub-CICM filter's output. M is an integer with a value greater than or equal to 1. K is an integer greater than 1 but less than or equal to M.

At least one sub-CICM filter 320 out of the M sub-CICM filters 320,330,340,350 includes a sub-filter 410 that performs the equation 1 mentioned above, a digital automatic gain control block 480, and a down sampler 490. An input signal in at least one sub-CICM filter 320 out of the M sub-CICM filters 320,330,340,350 passes through the LPF 410, the DAGC1 480, and through the down sampler 490 sequentially in that order.

The LPF 410 may include N functional blocks (N Integrator & Differentiator blocks) 420, 430, 440, each including adders 420, 421 and delay blocks 422, 423 to perform the integral and derivative functions.

The LPF 410 may include N functional blocks (N Delay Adders) 450, 460, 470. Each of the N functional blocks may include L delay blocks 451, 452, 453 each of which are connected in cascade form, and an adder 454 which adds the output of L delay blocks 451, 452, 453.

### Example 2

The present invention can be an embodiment of a radio frequency analog signal demodulation method.

The first stage is to convert the RF analog signal to a digital signal. The second stage is to convert the signal to have a center frequency of DC and separate the I and Q data. The third stage is to demodulate the I AND Q data. The first stage may be performed by using more than one of the following: an antenna 100, an RF processing block 110, and AGC 120, and an ADC 130. The second stage may be performed using a digital mixer 210. The third stage may be performed by using a DFE filter 220 and a BB modem 150.

Different from the first example, the second stage can be performed by the DFE 140 and the third stage can be performed by the BB modem 150.

According to the present invention, the DFE which is conventionally performed in analog blocks, can now be implemented in digital logic. As a result, developmental costs, area, and power consumption can be reduced while supporting multi-mode, multi-band applications. In addition, a digital mixer prevents I AND Q mismatching. Also, by using integer/rational number decimation, multi-mode (standard) sampling is supported. Moreover, a feedback digital AGC that determines the feedback output of a filter that operates at high speed, and a feed-forward digital AGC that adjusts the size of the signal enables the system to achieve the required SNR.

The embodiments of the present invention have been disclosed above for illustrative purposes. Those skilled in the art will appreciate that various modifications, additions and substitutions are possible, without departing from the scope and spirit of the invention as disclosed in the accompanying claims.

What is claimed is:

1. A digital receiver for mobile communications, comprising:
an Analog-to-Digital Converter (ADC) configured to convert a radio frequency analog signal to a digital signal;
a Digital Front End including a digital mixer to convert the ADC output signal to have a center frequency at DC, and a filter to satisfy a multi-band signal through automatic gain control; and
a modem configured to receive the Digital Front End's output signal and perform demodulation.

2. The digital receiver of claim 1, wherein the clock rate of a clock inputted to digital mixer is configured to have the same speed as the sampling rate of the output signal of the ADC.

3. The digital receiver of claim 1, wherein the digital mixer comprises:
a numerical controlled oscillator and a multiplier for separating the output signal of the ADC into an in-phase signal and a quadrature-phase signal.

4. The digital receiver of claim 1, wherein the Digital Front End comprises:
a Digital Front End filer configured to remove the noise of the output signal of the ADC in order to obtain the Signal-to-Noise Ratio required by the modem.

5. The digital receiver of claim 4, wherein the Digital Front End comprises:
a Cascaded Integrator Comb filter configured to receive the output of the digital mixer;
a first Finite Impulse Response filter configured to receive the output of the Cascaded Integrator Comb filter;
a Sample rate converter configured to receive the output of the first Finite Impulse Response filter;
a second Finite Impulse Response filter configured to receive the output of the Sample rate converter; and
a digital automatic gain control block configured to receive the output of the second Finite Impulse Response filter.

6. The digital receiver of claim 5, wherein the digital automatic gain control block identifies a valid bit of the output of the digital front end filter in order to handle fluctuation of the signal magnitude due to a interference signal or characteristics of the multi-band signal.

7. The digital receiver of claim 4, wherein the digital front end filter converts the sampling rate of the ADC output to match the sampling rate required by the modem.

8. The digital receiver of claim 4, wherein the Digital Front End filter decimates the input signal.

9. The digital receiver of claim 5, wherein the Cascaded Integrator Comb filter includes a MUX and a plurality of Sub-Cascaded Integrator Comb filters.

10. The digital receiver of claim 5, wherein the digital automatic gain control block has a feed-forward structure and comprises:
a control signal generator;
a power detector;
a power estimation block;
a normalization block; and
a digital Variable Gain Amplifier (DVGA).

11. The digital receiver of claim 5, wherein the Cascaded Integrator Comb (CIC) filter comprises:
“M” sub-CICM filters, where the ‘k’-th sub-CICM filter receives the output of the ‘(k−1)’-th sub-CICM filter; and
a multiplexer that receives the outputs of the “M” sub-CICM filters,
wherein “M” is an integer with a value greater than or equal to 1, and ‘K’ is an integer greater than 1 but less than or equal to “M”.

12. The digital receiver of claim 11, wherein at least one sub-CICM filter of the M sub-CICM filters comprises:
a sub-filter that performs the function of
$${( \frac{1 - {z}^{- K}}{1 - {z}^{- 1}} )}^{N} ,$$
a digital automatic gain control block, and
a downsampler,
wherein an input signal to the at least one sub-CICM filter passes through the sub-filter, the digital automatic gain control block, and finally to the down sampler, in that sequential order.

13. The digital receiver of claim 12, wherein the sub-filter comprises N functional blocks,
wherein each of the N functional blocks contains adders and delay blocks used to perform integral and derivative functions.

14. The digital receiver of claim 12, wherein the sub-filter comprises N functional blocks, and
wherein each of the N functional blocks comprises L delay blocks each of which are connected in cascade form, and an adder which adds the output of L delay blocks.

15. An operating method of a digital receiver, comprising:
converting a radio frequency analog signal to a digital signal;
converting the center frequency of the digital signal to DC and separating the converted digital signal into an in-phase signal and a quadrature-phase signal; and
filtering the in-phase signal and the quadrature-phase signal with a digital front-end filter which conducts digital automatic gain control, and demodulating the filtered signals.
